(19) United States
(12) Patent Application Publication
(10) Pub. No.: US 2013/0042705 A1
(43) Pub. Date: Feb. 21, 2013

(54) MEASURING APPARATUS

(71) Applicants: Bernd Kolmanz, Wien (AT); Alexander Magrutsch, Wien (AT)

(72) Inventors: Bernd Kolmanz, Wien (AT); Alexander Magrutsch, Wien (AT)

(73) Assignee: Thomastik-Infeld Gesellschaft m.b.H., Wien (AT)

(21) Appl. No.: 13/397,310

(22) Filed: Feb. 15, 2012

Related U.S. Application Data
(60) Provisional application No. 61/443,479, filed on Feb. 16, 2011.

(30) Foreign Application Priority Data
Feb. 16, 2011 (AT) A 202/2011

(51) Int. Cl. G01N 37/00

(52) U.S. Cl. 73/864.91

(57) ABSTRACT

A measuring apparatus for measuring the thickness of a strip includes a support having a measuring zone and a measuring sensor having a measuring tip for cooperation with the support in the measuring zone, with the measuring sensor having an indicator element. A bearing arrangement movably supports the measuring sensor substantially normal to the support and is constructed as a fluid bearing. A position sensor records a position of the indicator element of the measuring sensor.

### CROSS-REFERENCES TO RELATED APPLICATIONS

This application claims the benefit of prior filed U.S. provisional Application No. 61/443,479, filed Feb. 16, 2011, pursuant to 35 U.S.C. 119(e), the content of which is incorporated herein by reference in its entirety as if fully set forth herein.

This application also claims the priority of Austrian Patent Application, Serial No. A 202/2011, filed Feb. 16, 2011, pursuant to 35 U.S.C. 119(a)-(d), the content of which is incorporated herein by reference in its entirety as if fully set forth herein

### BACKGROUND OF THE INVENTION

The present invention relates to a measuring apparatus.

The following discussion of related art is provided to assist the reader in understanding the advantages of the invention, and is not to be construed as an admission that this related art is prior art to this invention.

It is known measure a thickness of a strip using a measuring apparatus in which the strip is guided between a measuring sensor and a support. This type of measuring apparatus has shown to be disadvantageous because of the imprecision in the measurement of the strip thickness especially in the case of thicknesses in the range of beneath 2000 μm.

It would therefore be desirable and advantageous to provide an improved measuring apparatus which obviate prior art shortcomings and which is capable to measure strips, plates, wires or the like with thicknesses beneath 2000 μm at high precision in a simple way.

### SUMMARY OF THE INVENTION

According to one aspect of the present invention, a measuring apparatus for measuring the thickness of a strip includes a support having a measuring zone, a measuring sensor having a measuring tip for cooperation with the support in the measuring zone, the measuring sensor having an indicator element, a bearing arrangement to movably support the measuring sensor substantially normal to the support, said bearing arrangement being constructed as a fluid bearing, and a position sensor for recording a position of the indicator element.

The present invention resolves prior art problems by advantageously providing a substantially friction-free mounting of the measuring sensor to thereby enable a determination of the thickness of the strip with high precision. Furthermore, favorable centering of the measuring tip can be ensured, so that precision can be improved even further. It is further advantageous that the temperature of the measuring sensor can be kept at a substantially constant level, suitably with a temperature-stabilizing fluid, and measuring errors as a result of thermal expansions can be prevented.

According to another aspect of the present invention, a method for measuring the thickness of a strip includes pressing the strip against a support in a measuring zone of the support by a measuring sensor which is movably mounted substantially normal to the support by a bearing arrangement configured as a fluid bearing, maintaining a measuring tip of the measuring sensor in contact with the strip, recording a position of an indicator element of the measuring sensor by a position sensor, and determining a thickness of the strip from data recorded by the position sensor.

### BRIEF DESCRIPTION OF THE DRAWING

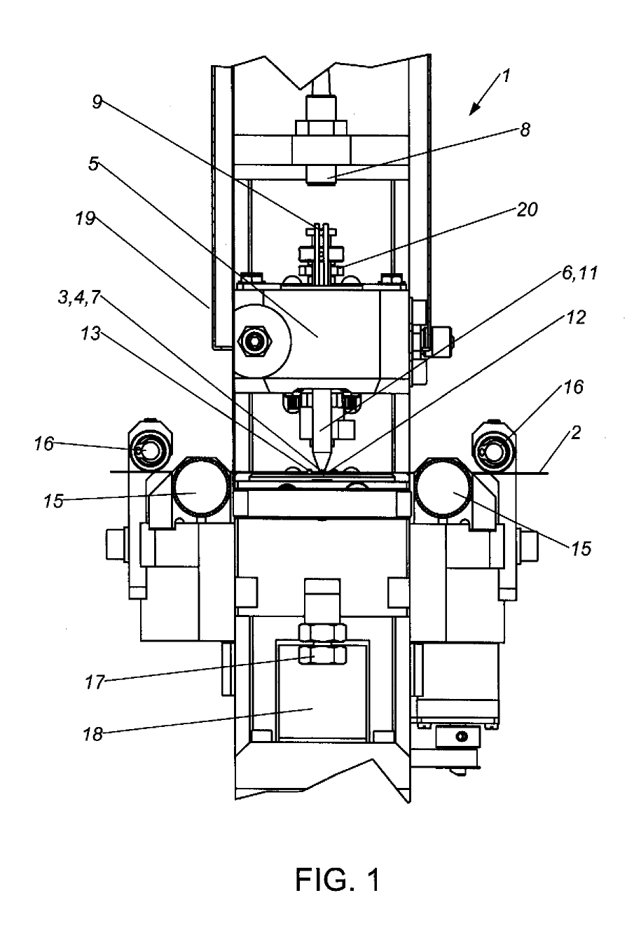

Other features and advantages of the present invention will be more readily apparent upon reading the following description of currently preferred exemplified embodiments of the invention with reference to the accompanying drawing, in which the sole FIG. 1 shows a vertical sectional view of a measuring apparatus according to the present invention;

### DETAILED DESCRIPTION OF PREFERRED EMBODIMENTS

The depicted embodiment is to be understood as illustrative of the invention and not as limiting in any way. It should also be understood that the FIGURE is not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a vertical sectional view of a measuring apparatus according to the present invention, generally designated by reference numeral 1 for measuring the thickness of a strip 2. The measuring apparatus 1 includes a support 4 having a measuring zone 3 and a measuring sensor 6 which is movably held substantially normally to the support 4 by a bearing arrangement 5. The measuring sensor 6 has a measuring tip 7 for cooperation with the support 4 in the measuring zone 3. A position sensor 8 records the position of an indicator element 9 of the measuring sensor 6. The bearing arrangement 5 is constructed as a fluid bearing so as to advantageously attain a substantially friction-free bearing of the measuring sensor 6 and to be able to determine the thickness of the strip 2 with high precision. Furthermore, favorable centering of the measuring tip 7 can be ensured, by means of which the precision can be increased even further. It is further advantageous that the temperature of the measuring sensor 6 can be kept at a substantially constant level and measuring errors as a result of thermal expansions can be avoided.

While the measuring apparatus 1 is used primarily for measuring the thickness of a strip 2, it will be understood by persons skilled in the art that a measuring apparatus 1 in accordance with the invention is, of course, applicable for other applications as well. A body to be measured can also be configured for example as a wire or plate, or may have any other shape and may have flat and/or substantially plane-parallel areas at least in sections. A strip has a longitudinal direction, the magnitude of which is substantially larger in comparison with the cross-sectional dimensions of a cross section normal to the longitudinal direction. A plate has a surface area with a thickness which is substantially less in comparison with the dimensions of the area.

The body to be measured can be made of metal, plastic or ceramics. Bodies made of metal are especially suitable for measurement. For the purpose of a concise and clear definition, the body whose thickness is to be measured shall be designated below as strip 2.

The strip 2 is disposed during thickness measurement between the measuring tip 7 and the support 4. The support 4 has advantageously a substantially planar surface.

Suitably, a transport apparatus can be provided for the transport of the strip 2 over the support 4. As a result, the thickness of the strip 2 can advantageously be measured along its longitudinal axis. The thickness of the strip 2 can especially be measured and checked continuously during the running production process. The transport apparatus can be arranged directly on the measuring apparatus 1 for example. The transport apparatus can also be arranged as a module which is independent of the measuring apparatus 1.

The measuring apparatus 1 can also be used for measuring the thickness of a static body. In this case, the measuring apparatus 1 is moved.

At least one guide roll 15 is arranged for guiding the strip 2 on the support 4. The guide roll 15 can comprise a gap which can be adjusted to the width of the strip 2 and in which the strip 2 can be guided. By placing the strip 2 on the base of the gap, a three-side guidance of the strip 2 can be ensured in a simple way, by means of which a predeterminable movement of the strip 2 over the support 4 and especially in the measuring zone 3 can be achieved in a simple way.

At least one counter roll 16 is provided for cooperation with the at least one guide roll 15 for the purpose of vertical guidance of the strip 2. The counter roll 16 is configured to press the strip 2 against the guide roll 15. Disturbing movement components of the strip 2 can be calmed in this way and it can be ensured that the strip 2 remains in the guidance of the guide roll 15. As a result, the thickness of the strip 2 can also be measured at high speed, e.g. higher than 250 m/min, preferably higher than 500 m/min, especially higher than 750 m/min. Furthermore, damage to the measuring apparatus 1 by an uncontrolled movement of the strip 2 can be prevented thereby.

Currently preferred is an arrangement in which at least one of the guide rolls 15 and one of the counter rolls 16 are arranged on each of both sides of the support 4, wherein a moving strip 2 can reliably be guided along a predeterminable movement path in the region of the support.

A rotational element 12 is arranged around the measuring zone 3 for lateral guidance of the strip 2. As a result, a movement of the strip out of the measuring zone 3 can be prevented and the reliability and precision of the result of the measurement can be improved. The rotational element 12 comprises two guides 13 which are arranged with respect to the measuring zone 3 at two opposite points close to the center. The strip 2 can be guided between the guides 13, with a lateral displacement of the strip 2 being prevented by the guides 13.

The guides 13 are configured as pins and protrude over the support 4 parallel to the rotational axis of the rotational element 12. The guides 13 can be adjusted to different widths of the strip 2 by rotating the rotational element 12, with the strip 2 being guided in a precise and centered manner through the measuring zone 3.

The support 4 is advantageously constructed for height adjustment with respect to the guide roll 15. As a result, the position of the support 4 in relation to the strip 2 and therefore the distance between the support 4 and the strip 2 or the pressure of the strip 2 on the support 4 can be predetermined. The measuring zone 3 is only height-adjustable with respect to the guide roll 15. The measuring zone 3 can be set independent of the area of the support 4 enclosing the measuring zone 3.

Advantageously, the height of the support 4 is chosen in such a way that the strip 2 touches the support 4 in such a way that the distance between the support 4 and the strip 2 and the pressure of the strip 2 on the support 4 is minimal. Measuring errors and strong wear and tear of the support 4 can be prevented thereby.

The support 4 is made in the measuring zone 3 from a material which is very hard and therefore unyielding, and has a low coefficient of friction and a low coefficient of thermal expansion. The support 4 in the measuring zone 3 can be made of metal, ceramics, gemstones such as diamonds, or suitable minerals such as oxides or nitrides with crystalline or amorphous crystalline structure. Furthermore, wear and tear is kept at a low level by the choice of hard material, by means of which a longer service interval can be chosen.

The measuring zone 3 of the support 4 is configured to be translucent, especially transparent. In this way, it can be checked whether the strip 2 is disposed in the measuring zone 3, and/or the thickness of the strip 2 is measured at the desired position or line. This support 4 is preferably made of a wear-proof material of low thermal expansion.

An optical apparatus 17, especially an objective, is arranged beneath the support 4. As a result, the position of the strip 2 in the measuring zone 3 can be determined with high precision, with the likelihood of a systematic measuring error caused by adverse positioning being prevented. Arranged beneath the optical apparatus 17 is a mirror 18 which is suitably set in such a way that the position of the strip 2 in the measuring zone 3 can be positively identified from the outside. As a result, a rapid and simple verification of the position of the strip 2 in the measuring zone 3 can be made from the outside.

Although not shown in detail, an image processing system such as a camera with a CCD chip can be arranged beneath the support 4 or the optical apparatus 17. A continuous monitoring of the position of the strip 2 in the measuring zone 3 can occur thereby and can be sent to a computer with an image recognition program, by means of which the position of the strip 2 in the measuring zone 3 can be readjusted automatically, or the measurement can be stopped automatically when the strip 2 is situated outside of a predeterminable position.

The thickness of the strip 2 leads to the consequence that the position of the measuring sensor 6 whose measuring tip 7 touches the strip 2 will change.

The measuring sensor 6 is configured as a measuring rod 11. As a result, a direct relationship between the thickness of the strip 2 and the vertical position of the measuring sensor 6 is achieved. The contact force with which the measuring sensor 6 rests with its measuring tip 7 on the strip 2 is preferably the gravitational force. As a result, this contact force remains constant irrespective of the thickness of the strip 2, so that a precise measurement can be realized irrespective of the thickness of the strip 2. The minimum contact force depends on the own weight of the measuring sensor 6. As a result, a precise measurement with simultaneously low wear and tear of the support 4 and/or the measuring tip 7 can be achieved. The contact force can be chosen to such an extent that the contact of the strip is ensured and a negative influence on the result of the measurement is prevented.

The contact force, or at least a part of the contact force, may be applied magnetically, chemically and/or fluidically.

The measuring sensor 6 may include a receiver for additional weights. The contact force can thereby be adjusted in a simple and rapid manner to the respective conditions. The measuring sensor 6 is made of a rigid material of low thermal expansion. For example, the measuring sensor 6 can be made of metal, rock, diamond, ceramics, minerals of crystalline or amorphous crystalline structure, plastic, glass fiber composites, carbon fiber composites or other composite materials. A precise measurement can be achieved by a low thermal expansion and/or a high dimensional stability of the measuring sensor 6.

The measuring rod 11 and the measuring tip 7 can be constructed as two parts. As a result, the measuring rod 11 and the measuring tip 7 can be made of different materials, with the material of the measuring rod 11 having a low thermal expansion and the material of the measuring tip 7 having low wear and tear. The measuring tip 7 is advantageously made of a hard wear-proof material which is of low friction. For example, the measuring tip 7 can be made of metal, rock, diamond, ceramics, or suitable materials of crystalline or amorphous crystalline structure. Wear and tear is kept at a low level thereby, so that constant measuring conditions are achieved over a prolonged period of time and long service intervals are possible. As a result of the low friction, a low amount of frictional heat is released, so that the measurement can also be performed over a prolonged period of time under substantially constant conditions. The thickness of the strip 2 can be determined thereby often and/or continuously.

The geometry of the measuring tip 7 can suitably be adjusted to the conditions at hand, e.g. to an approximate point-shaped contact, an approximate line contact or an approximate surface contact.

The measuring tip 7 is advantageously connected in a rigid manner with the measuring rod 11. Such rigid connection can occur for example by an interlocking, frictional engaged, non-positive or adhesive connection.

In order to determine the position of the measuring sensor 6, a position sensor 8 for recording the position of an indicator element 9 of the measuring sensor 6 is provided. The position sensor 8 suitably records the position of the indicator element 9 in a contact-free manner. The indicator element 9 can be arranged at the upper end of the measuring sensor 6, as shown in FIG. 1. This enables a simple measurement, with the indicator element 9 not obstructing the handling with the measuring sensor 6. As an alternative, the indicator element can also be arranged in the region of the measuring tip 7. As a result, the influence of thermal expansion of the measuring sensor 6 on the result of the measurement can be kept at an especially low level.

The position sensor 8 can interact for example with the indicator element 9 by way of a magnetic or electrostatic force, or the position sensor 8 and the indicator element 9 can be arranged as a capacitive element, with the capacitance being changed by changing the position of the indicator element 9 relative to the position sensor 8. For example, the position sensor 8 can be arranged as a capacitive system, preferably as a capacitive distance sensor. A high cycle rate and high resolution can be achieved thereby. The position sensor 8 can alternatively be constructed as an eddy-current distance sensor. A high resolution can also be achieved thereby, with said sensor being especially insensitive to temperature fluctuations and contamination. Furthermore, the position sensor 8 can also be configured as a radar distance sensor or as a magneto-inductive distance sensor.

The position sensor 8 can also be constructed as an ultrasonic sensor with a sonic nozzle. A precise measurement in combination with a simultaneously large measuring range can be achieved thereby. Also possible is a configuration of the position sensor 8 as an optical system. As a result, the movement of the measuring sensor 6 can occur independent from the position sensor 8, wherein especially the actions of force of the position sensor 8 on the measuring sensor 6 which influence the result of the measurement can be avoided. Furthermore, the freedom of movement of the measuring sensor 6 will not be limited by the position sensor 8.

For example, the position sensor 8 can be constructed as a confocal sensor. A high resolution can be achieved thereby, with the confocal sensor advantageously having a linear relationship between the measuring magnitude and position of the indicator element 9.

The position sensor 8 can also be configured as a chromatic confocal sensor. It offers the highest resolution and does not need any movable parts.

The position sensor 8 can also be configured as an infrared distance sensor. A large measuring range can be achieved thereby.

For example, the position sensor 8 can be configured as a laser triangulation sensor. A large measuring range in combination with high resolution can be achieved thereby.

Furthermore, the position sensor 8 can also operate according to the principle of interferometric submicrometer measuring technology. The highest possible resolutions can be achieved thereby.

The position sensor 8 can also operate according to the principle of optical shadow casting. In this process, the indicator element 9 is disposed between a light source and a light sensor. By evaluating the cast shadow, the position of the indicator element 9 and therefore the distance between the support 4 and the measuring tip 7 can be determined precisely.

Advantageously, the position sensor 8 can include a second sensor which measures the distance between the position sensor 8 and the support 4. As a result, the error can be determined and corrected which is produced in such a way that the frame on which the position sensor 8 is arranged will expand as a result of the temperature. Furthermore, the thermal expansion of this frame can be determined by means of an expansion measurement, e.g. with a wire strain gauge. In order to reduce the thermal expansion of the frame, the frame can be tempered for the duration of the measurement.

The position sensor 8 and the indicator element 9 can be enclosed by a housing 19. This prevents any errors of the position sensing of the indicator element 9 by foreign bodies such as dust, metal dust, corundum, humidity or scattered light.

As described above, the bearing arrangement 5 is constructed as a fluid bearing. It has been shown that an especially high measuring precision can be achieved thereby. The fluid bearing can especially be operated with a temperature-stabilized fluid. The temperature of the measuring sensor 6 can be kept substantially constant by means of the fluid.

In particular, a rapid response of the measuring sensor 6 can be achieved thereby, wherein the force with which the measuring sensor 6 rests on the strip 2 can freely be chosen over a large range.

The measuring sensor 6 is movably mounted in the bearing arrangement 5 substantially normal to the support 4.

The bearing arrangement 5 can be configured as a static sliding bearing. A static sliding bearing is a sliding bearing in which the fluid is pressed from the outside into the gap between the measuring sensor 6 and the bearing arrangement 5. A substantially friction-free bearing of the measuring sensor 6 can be achieved thereby.

Advantageously, the thickness of the gap between the measuring sensor 6 and the bearing arrangement 5 is very small. A precise positioning of the measuring sensor 6 can be achieved thereby.

A fluid, especially a temperature-stabilized fluid, such as lubricating oil or water, or a gas, especially a temperature-stabilized gas, such as nitrogen, noble gases, air, especially dried air, can be used as the fluid.

The fluid bearing may also be configured as a dynamic sliding bearing, with a friction-reducing effect of the fluid being produced by a purposeful rotation of the measuring sensor 6 in the bearing arrangement 5.

Currently preferred is a configuration of the fluid bearing as a gas bearing, especially an air bearing. A substantially friction-free bearing of the measuring sensor 6 and consequently a high measuring precision of the measuring apparatus 1 can be achieved thereby. This further prevents the likelihood that any escaping fluid will contaminate the measuring apparatus 1, will distort the result of the measurement and/or will damage the measuring apparatus 1 or a subsequent apparatus in the production process of the strip 2. Advantageously, the gas to be used is air, especially dried air. This avoids the necessity of having to collect and remove the used gas. Air, especially dried air, is temperature-stabilized. As a result, the temperature of the measuring sensor 6 can be kept at a substantially constant level, so that measuring errors which are caused by thermal expansions can be kept at a low level.

The fluid can be introduced through several fluid channels into the gap between the measuring sensor 6 and the bearing arrangement 5.

The fluid bearing includes a porous material, especially a porous sintered material, for fluid guidance. This allows achieving a highly constant static pressure for bearing the measuring sensor 6, thereby preventing any jamming of the measuring sensor 6.

Suitably, the angle of twist of the measuring sensor 6 during a rotation about the longitudinal axis of the measuring sensor can be predetermined or controlled. if the measuring tip 7 is arranged off-center of the rotational axis, a fine adjustment of the position of the measuring tip 7 on the strip 2 can occur by a purposeful twisting of the measuring sensor 6. When the rotation of the measuring sensor 6 is continued, it is not only possible to determine the thickness along a line of the strip 2, but it is also possible to make further statements on the shape of the strip 2 such as a curvature by a sinusoidal progression of the measuring points on the strip 2.

A control of the angle of twist of the measuring sensor 6 can be made directly on the measuring sensor by way of magnets for example. Furthermore, a control of the angle of twist of the measuring sensor 6 can occur via a rotational movement of the bearing arrangement 5.

The position of the measuring sensor 6 can be predetermined in an especially simple way when the cross section of the measuring sensor 6 is not rotationally symmetrical, e.g. oval or polygonal, especially quadrangular. It can be ensured in these measuring sensors 6 in a very simple way that the measuring sensor 6 will follow the rotational movement of the bearing arrangement 5.

In order to realize a controlled placing and lifting of the measuring sensor 6 on the strip 2, the measuring apparatus 1 includes a lifting device 20. The lifting device 20 can be constructed as a piston with the protrusion which is vertically movable and rests from below on a protrusion of the measuring sensor 6 in order to lift the measuring sensor 6 on this protrusion. The measuring sensor 6 merely rests with the force of its own weight on the lifting device 20. As a result, the measuring sensor 6 can be placed on and lifted from the strip 2 in a controlled manner so that damage can be avoided.

The bearing arrangement 5 is movable substantially parallel to the support 4 by means of a moving device. As a result, the zero point of the measuring apparatus 1 can be checked in a simple way, in that the measuring sensor 6 is placed on the support 4 next to the strip 2, also when the strip 2 is still moving. The moving device can be electronically controllable. The verification of the zero point position can automatically occur at predeterminable points in time, and/or when certain predeterminable conditions are fulfilled. As a result, a reliable measurement can also be ensured over a prolonged period of time. The moving device can be configured in such a way that the position of the strip 2 where the thickness is measured can be precisely predetermined. It can especially be provided that the thickness of the strip 2 will be measured along a sinus curve. Further information on the shape of the strip 2 can be obtained thereby.

Only the bearing arrangement 5 can be made movable by the moving device. The mass to be moved can be kept at a low level in this way, enabling a precise positioning of the bearing arrangement 5.

In the case of a suitable choice of the support 4, the measuring sensor 6, the bearing arrangement 5, and the checking and consideration of various error sources such as the thermal expansion, the resolution of the measuring apparatus 1 will be in the nanometer range, e.g. 110 nm, especially 10 nm.

The support 4 and the bearing arrangement 5 can be displaceably mounted relative to the guide roll 15. As a result, both the support 4 and also the bearing arrangement 5 can be removed from the strip 2 in order to perform maintenance work without obstructing a running production process.

Advantageously, the support 4 and the bearing arrangement 5 are arranged on a common guide element, with the movement of the support 4 and the bearing arrangement 5 occurring jointly and being substantially normal to the direction of movement of the measuring sensor 6 in the bearing arrangement 5. It can further occur substantially normal to the direction of movement of the strip 2.

The invention further relates to a method for measuring the thickness of a strip 2, with the strip 2 being arranged on support 4 comprising the measuring zone 3, wherein the strip 2 is pressed against the measuring zone 3 by measuring sensor 6 which is movably mounted substantially normal to the support 4 by bearing arrangement 5 which is configured as a fluid bearing, with the measuring tip 7 of the measuring sensor 6 being kept in contact with the strip 2, wherein the position of an indicator element 9 of the measuring sensor 6 is recorded by position sensor 8, and the thickness of the strip 2 is determined from the data of the position sensor 8.

The advantages as mentioned above can be achieved in this manner. This leads to the advantage that the thickness of the strip 2 can be determined with high precision as a result of the substantially friction-free bearing of the measuring sensor 6. Furthermore, a favorable centering of the measuring tip 7 can further be achieved, so that measuring errors are kept at a low level. It is further advantageous that a substantially constant cooling of the measuring sensor 6 is achieved by the fluid bearing, by means of which errors caused by thermal expansions are kept at a low level.

Further embodiments in accordance with the invention merely have a part of the described features, wherein any combination of features can be provided, especially also such of different described embodiments.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A measuring apparatus for measuring the thickness of a strip, comprising:
a support having a measuring zone;
a measuring sensor having a measuring tip for cooperation with the support in the measuring zone, said measuring sensor having an indicator element;
a bearing arrangement to movably support the measuring sensor substantially normal to the support, said bearing arrangement being constructed as a fluid bearing; and
a position sensor for recording a position of the indicator element.

2. The measuring apparatus of claim 1, wherein the fluid bearing is a gas bearing.

3. The measuring apparatus of claim 1, wherein the fluid bearing comprises a porous material for fluid guidance.

4. The measuring apparatus of claim 1, wherein the measuring sensor is constructed as a measuring rod.

5. The measuring apparatus of claim 1, wherein the measuring sensor comprises a receiver for additional weights.

6. The measuring apparatus of claim 1, wherein the measuring zone of the support is configured to be translucent.

7. The measuring apparatus of claim 1, wherein the measuring zone of the support is configured to be transparent.

8. The measuring apparatus of claim 1, wherein the position sensor is constructed as a capacitive system.

9. The measuring apparatus of claim 1, wherein the position sensor is constructed as an optical system.

10. The measuring apparatus of claim 1, further comprising a rotational element having guides for lateral guidance of the strip around the measuring zone.

11. The measuring apparatus of claim 1, wherein the support is constructed for height adjustment.

12. The measuring apparatus of claim 1, further comprising a moving device to move the bearing arrangement in substantial parallel relation to the support.

13. The measuring apparatus of claim 1, further comprising at least one guide roll for guiding the strip on the support, wherein the support and the bearing arrangement are displaceably mounted relative to the guide roll.

14. The measuring apparatus of claim 13, wherein the measuring zone is height-adjustable only with respect to the guide roll.

15. A method for measuring the thickness of a strip, comprising:
pressing the strip against a support in a measuring zone of the support by a measuring sensor which is movably mounted substantially normal to the support by a bearing arrangement configured as a fluid bearing;
maintaining a measuring tip of the measuring sensor in contact with the strip;
recording a position of an indicator element of the measuring sensor by a position sensor; and
determining a thickness of the strip from data recorded by the position sensor.
